(19) United States
(12) Patent Application Publication
(10) Pub. No.: US 2014/0026765 A1
(43) Pub. Date: Jan. 30, 2014

(54) BARBECUE GRILL

(71) Applicants: Augustine Fou, New York, NY (US); Joseph Fou, Dallas, TX (US)

(72) Inventors: Augustine Fou, New York, NY (US); Joseph Fou, Dallas, TX (US)

(21) Appl. No.: 13/561,291

(22) Filed: Jul. 30, 2012

(51) Int. Cl. A23B 4/052; A47J 37/07

(52) U.S. Cl. CPC A23B 4/0523; A47J 37/07
USPC 99/445

(57) ABSTRACT

A cooking surface for a grill includes a fire column. Food placed on the grill surface directly above the fire column will be impinged by the heat of the heat source, made even more intense by the upward, directional flow of air through the fire column. Food placed on the grill surface but not directly above the fire column can be cooked with indirect heat.

### CROSS-REFERENCE TO RELATED APPLICATIONS

This application claims priority under 35 U.S.C. §120 to U.S. patent application Ser. No. 11/894,853 entitled “BARBECUE GRILL” filed in the name of Augustine Fou et al. on Aug. 22, 2007, now U.S. Pat. No. 8,230,848, which in turn claims priority under 35 U.S.C. §119 to U.S. Provisional Patent Application Ser. No. 60/839,232 entitled “BARBECUE GRILL” filed in the name of Augustine Fou et al. on Aug. 22, 2006, the entirety of each of which is herein incorporated by reference.

### TECHNICAL FIELD

The present disclosure generally relates to barbecue and smoker grills.

### BACKGROUND OF THE DISCLOSURE

Typical barbecue grills have a chamber in which a heat source, such as charcoal or gas burners, is underneath the cooking surface where the food is placed. By placing the food directly above the heat source, direct cooking is achieved. Indirect cooking is achieved by placing the food off to the side and not directly above the heat source; or moving the heat source to the side. However, most barbecue grills do not achieve high enough temperatures to achieve the desirable browning or blackening of food items known as the maillard reaction in a short amount of time. It takes a long cooking process to achieve proper browning or blackening, in which case the food is overcooked.

Furthermore when barbecues are operated at the highest possible temperatures, for example when hardwood charcoal is used, the burning charcoal does not give off much aromatic smoke. Smoke is only given off when the wood is burning low, also known as smoldering.

Finally smokers which do use smoldering wood typically have the smoking source in a separate chamber that is connected to the main chamber in which the food resides. As such smokers cannot cook at the desired high temperatures.

Therefore, there is need for an improved grill which addresses these limitations of the prior art.

### SUMMARY OF THE DISCLOSURE

The present disclosure is a grill which can cook at extremely high temperatures to achieve the desirable maillard reaction in a short amount of time and also flavor the food with aromatic smoke at the same time.

### BRIEF DESCRIPTION OF THE DRAWINGS

Other objects, features, and advantages of the present disclosure will become apparent to one with skill in the art upon examination of the following drawings:

FIG. 1 is a first view of the barbecue grill of the present disclosure with its external doors open;

FIG. 2 is a second view of the grill of the present disclosure with its external doors closed;

FIG. 3 is an illustration of a smoker attachment for the grill of FIGS. 1 and 2;

FIG. 4 is an illustration of an alternate embodiment of a smoker attachment for a barbecue grill.

### DETAIL DESCRIPTION OF THE PREFERRED EMBODIMENTS

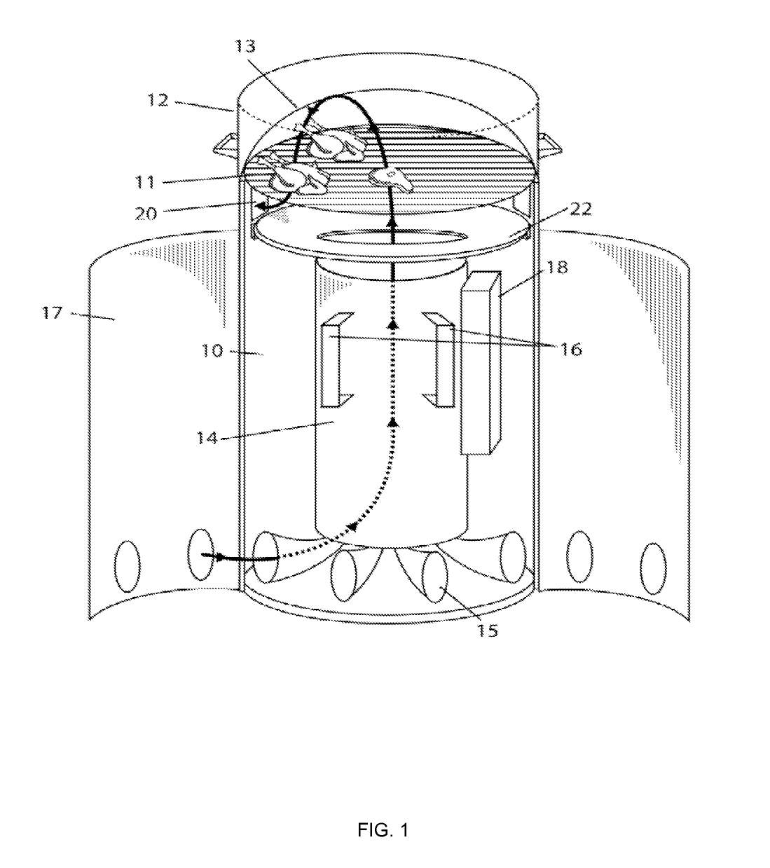

Reference will now be made to the details of the disclosure as illustrated in the drawings using reference numerals. As shown in FIG. 1, a preferred embodiment of the present disclosure is the wide cylindrical cooking chamber 10 whose walls consist of multiple internal layers of heat insulating materials and two external decorative layers that may be metallic. There is a cooking grill surface 11 and lid 12 with hemispherical inner lining 13. The cooking chamber contains a smaller cylinder inside of it and concentric to it, called the fire column 14. The fire column contains the heat source—for example charcoal briquettes or wood charcoal—and has air intakes 15 at its base and is open at the top. The fire column also has handles 16 so that it can be easily removed when the charcoal is spent. The fire column can be removed through double doors 17 on one side.

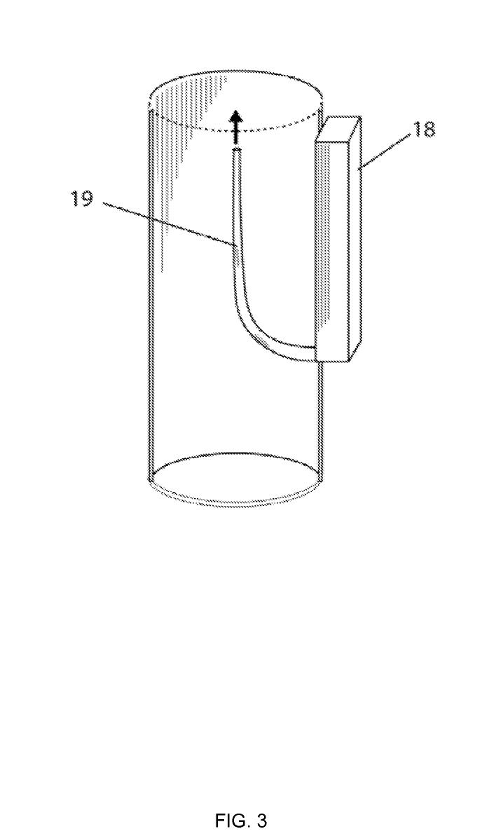

The fire column also has a smoking chamber attachment 18, also shown in detail in FIG. 3, mounted directly to the side wall. The smoking chamber contains the wood which is caused to smolder by the intense heat of the fire column and give off smoke which is injected into the center part of the fire column by directional airflow through metallic tube 19, also shown in detail in FIG. 3.

Food placed on the grill surface 11 directly above the circumference of the fire column 14 will be impinged by the heat of the heat source—e.g. hardwood charcoal—made even more intense by the upward, directional flow of air through the fire column, entering from its base through the intakes 15 and flowing straight up at the food placed above the fire column—creating a “jet engine” effect.

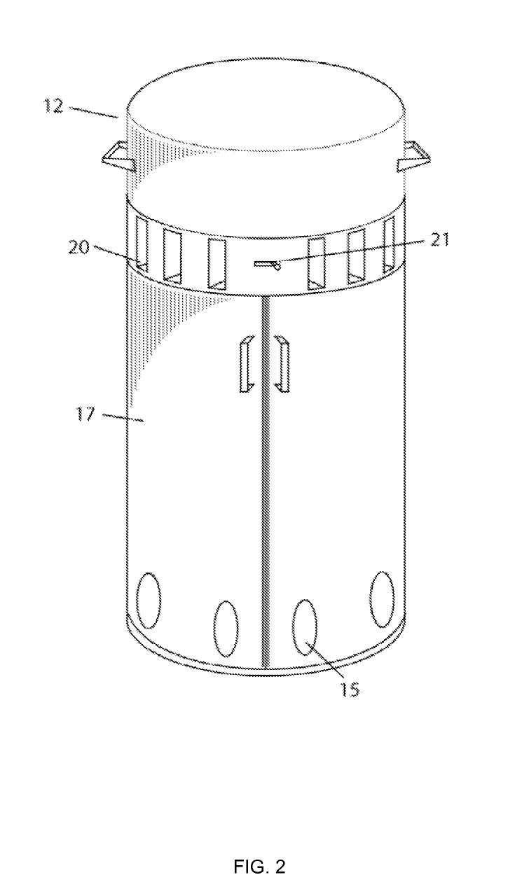

Food placed on the grill surface 11 but NOT directly above the fire column 14 (i.e. outside a circumference of the fire column 14 but within a circumference of the grill surface 11) can be cooked with indirect heat. When the lid 12 is placed on the cooking chamber 10, the intense heat of the fire column rises to impinge upon the hemispherical inner lining of the lid 13, flows back downward over the food and downward through the grill surface until it finally exits through the exhaust vents 20. The sliding baffle 21 (see FIG. 2) can be moved to change the size of the exhaust vents and thus control the amount and speed of the airflow. This controls the intensity of the fire flowing upward through the fire column and thus the temperature and speed of cooking.

A conical drip pan 22 collects drippings from the food and channels the drippings back into the central fire column, both to make the fire even more intense and also to add more flavor to the food.

In this way, the present disclosure solves the shortcomings of both barbecue grills and smoking grills—cannot impart good smoke flavor and cannot cook at extremely high heat, respectively. The present disclosure enables cooking at extremely high temperatures by utilizing directional airflow to “fan the flame” and channel the heat directly at the food. It also imparts better smoke flavor than conventional grills through the smoke injector.

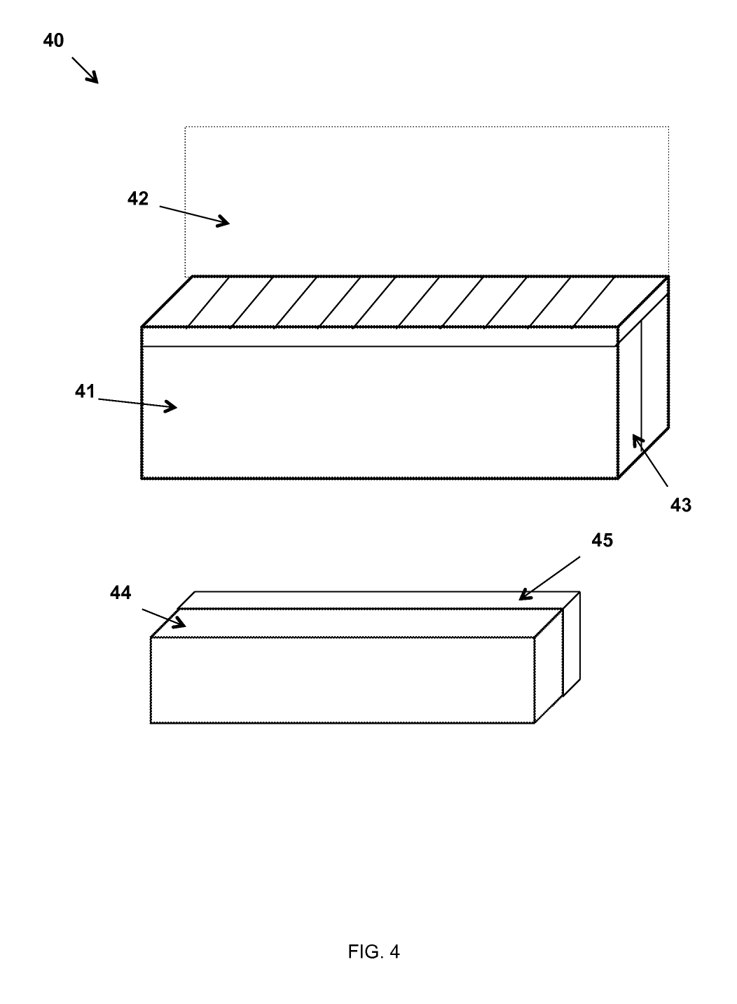

Turning to FIG. 4, therein is depicted an alternate, rectangular embodiment 40 of the barbecue grill and smoker described herein wherein the shape of the grill and smoking chamber are not cylindrical. It is readily contemplated that the barbecue grills with removable columns and smoking chambers as described herein may be any useful shape whatsoever, of which cylindrical and rectangular embodiments are depicted herein. The rectangular embodiment 40 depicts a rectangular cooking chamber 41 having a cover 42 and doors 43. When the doors 43 are opened, a rectangular fire column 44 may be removably disposed within the cooking chamber 41, as with previously described embodiments. The rectangular fire column 44 includes a rectangular smoking chamber 45, which uses heat from the rectangular fire column 44 to smolder a substance to generate smoke. The smoke may pass from a tube disposed between the rectangular fire column 44 and the smoking chamber 45. The rectangular fire column 44 is advantageous in that it may provide a greater cooking surface area than the previously described cylindrical embodiments for a given amount of space.

The foregoing description has been presented for purposes of illustration and description. It is not intended to be exhaustive or to limit the disclosure to the precise forms disclosed. Obvious modifications or variations are possible in light of the above teachings. All such modifications and variations, are within the scope of the disclosure as determined by the appended claims when interpreted in accordance with the breadth to which they are fairly and legally entitled.

What is claimed is:

1. A grill apparatus, comprising:
a cooking chamber having an outer wall;
the outer wall having a door disposed on a side surface;
a grill surface having a first circumference and disposed at a top of the cooking chamber;
the outer wall having a plurality of vents disposed circumferentially around the outer wall above the door and below the grill surface with a sliding baffle for controlling the size of the plurality of vents, such that the temperature near the grill surface may be controlled by the sliding baffle;
a fire column disposed beneath the grill surface within the outer wall of the cooking chamber grill apparatus, the fire column having an open top portion with a second circumference less than the first circumference, the cylindrical column further having an interior for holding a heat source on a base thereof and for providing directional heatflow from the heat source toward the open top portion and the grill surface;
a smoking chamber attachment mounted to an exterior side wall of the fire column and disposed beneath the grill surface and entirely within the outer wall grill apparatus, the smoking chamber attachment having a chamber for smoldering a substance using only heat from the heat source in order to generate smoke; and
a tube extending from the smoking chamber attachment through the side wall into the interior of the fire column, the tube for directing smoke generated within the chamber to the interior of the cylindrical column, thereby flavoring a food placed on the grill surface using the smoke, wherein the fire column is removable from the cooking chamber via the door.

2. The apparatus of claim 1, wherein the fire column further comprises at least one air intake vent disposed near the base of the fire column.

3. The apparatus of claim 2, further comprising at least one opening through the outer wall that is in communication with the air intake vent of the fire column.

4. The apparatus of claim 1, wherein the fire column further comprises a handle on the side wall for enabling removal of the fire column from the cooking chamber via the door.

5. The apparatus of claim 1, wherein the outer wall of the cooking chamber is substantially cylindrical and the fire column is substantially cylindrical.

6. The apparatus of claim 1, wherein the outer wall of the cooking chamber is substantially rectangular and the fire column is substantially rectangular.

7. The apparatus of claim 1, wherein food placed on the grill surface within the second circumference of the fire column will be cooked with greater intensity than food placed within the first circumference of the grill surface but outside the second circumference of the fire column.

8. The apparatus of claim 1, further comprising a lid having an inner surface for distributing indirect heat around the grill surface.

9. The apparatus of claim 1, wherein the substance comprises wood.

10. The apparatus of claim 1 further comprising:
a drip pan disposed above the column and below the grill surface within the cooking chamber, the drip pan having an opening in a bottom surface thereof and disposed over the open top portion of the fire column, the drip pan for collecting drippings from the grill surface and directing the drippings into the top portion of the fire column.

11. A cooking and smoking apparatus for use in conjunction with a grill apparatus having a grill surface, comprising:
a cooking chamber having an outer wall;
the outer wall having a door disposed on a side surface;
a grill surface having a first circumference and disposed at a top of the cooking chamber;
a fire column disposed beneath the grill surface within the outer wall of the cooking chamber, the fire column having an open top portion with a second circumference less than the first circumference, the fire column further having an interior for holding a heat source on a base thereof and for providing directional heat flow from the heat source toward the open top portion and the grill surface;
a smoking chamber attachment mounted to a side wall of the fire column and disposed beneath the grill surface entirely within the cooking chamber, the smoking chamber attachment having an interior for smoldering a substance and exclusively using heat from the heat source in order to generate smoke; and
a tube extending from the smoking chamber attachment through the side wall into the interior of the fire column, the tube for directing smoke generated within the smoking chamber to the interior of the fire column, thereby flavoring a food placed on the grill surface using the smoke, wherein the fire column is removable from the cooking chamber via the door.

12. The apparatus of claim 11, wherein the substance comprises wood.

13. The apparatus of claim 11, the outer wall having a plurality of vents disposed circumferentially around the outer wall above the door and below the grill surface with a sliding baffle for controlling the size of the plurality of vents, such that the temperature near the grill surface may be controlled by the sliding baffle.

14. The apparatus of claim 11, further comprising:
a drip pan disposed above the cylindrical column and below the grill surface within the cooking chamber, the drip pan having an opening in a bottom surface thereof and disposed over the open top portion of the fire column, the drip pan for collecting drippings from the grill surface and directing the drippings into the top portion of the fire column;

15. The apparatus of claim 11, wherein the fire column is substantially rectangular.

16. A cooking and smoking apparatus for use in conjunction with a grill apparatus having a grill surface, comprising:
a cooking chamber having an outer wall;
the outer wall having a door disposed on a side surface;
a grill surface having a first circumference and disposed at a top of the cooking chamber;
the outer wall having a plurality of vents disposed around the outer wall above the door and below the grill surface with a sliding baffle for controlling the size of the plurality of vents, such that the temperature near the grill surface may be controlled by the sliding baffle;
a column disposed beneath the grill surface within the outer wall of the cooking chamber grill apparatus, the column having an open top portion with a second circumference less than the first circumference, the column having an interior for holding a heat source on a base thereof and for providing directional heat flow from the heat source toward the open top portion and the grill surface;
a smoking chamber attachment mounted to a side wall of the column and disposed beneath the grill surface entirely within the cooking chamber grill apparatus, the smoking chamber attachment having a chamber for smoldering a substance using only heat from the heat source in order to generate smoke; and
a tube extending from the smoking chamber attachment through the exterior side wall into the interior of the column, the tube for directing smoke generated within the chamber to the interior of the column, thereby flavoring a food placed on the grill surface using the smoke, wherein the column is removable from the cooking chamber via the door.

17. The apparatus of claim 16, wherein the substance comprises wood.

18. The apparatus of claim 16, further comprising a drip pan disposed above the column and below the grill surface within the cooking chamber, the drip pan having an opening in a bottom surface thereof and disposed over the open top portion of the column, the drip pan for collecting drippings from the grill surface and directing the drippings into the top portion of the column.

19. The apparatus of claim 18, wherein the drip pan is substantially conical.

20. The apparatus of claim 16, wherein the column is substantially rectangular.
